(19) United States
(12) Patent Application Publication
(10) Pub. No.: US 2026/0336137 A1
(43) Pub. Date: Oct. 29, 2026

(54) SYSTEM AND METHODS FOR DEPLOYING END EFFECTOR OF A COLLABORATIVE ROBOT IN A GLOVEBOX

(71) Applicant: ATKINSRÉALIS UK LIMITED, Moor Row, Cumbria (GB)

(72) Inventors: Angus Richard FOSTER-HALL, Moor Row, Cumbria (GB); William Bernard WINDELL, Moor Row, Cumbria (GB); Robert Paul MARWOOD, Moor Row, Cumbria (GB)

(73) Assignee: ATKINSRÉALIS UK LIMITED, Moor Row, Cumbria (GB)

(21) Appl. No.: 19/487,807

(22) PCT Filed: May 29, 2024
(86) PCT No.: PCT/IB2024/055221

§ 371 Date: Nov. 25, 2025

Related U.S. Application Data
(60) Provisional application No. 63/504,788, filed on May 29, 2023.

(51) Int. Cl. B25J 21/02; B25J 15/04

(52) U.S. Cl. CPC B25J 21/02; B25J 15/04

(57) ABSTRACT

A system and method for deploying a collaborative robot in a glovebox are provided. The system comprises a collaborative robot having a proximate end and a distal end, the proximate end mounted to a collaborative robot mount, and the distal end comprising a tool mounting member. The tool mounting member comprises a tool interface for coupling to an end effector, and a mounting surface for coupling to a first sleeve, the mounting surface dividing a total surface of the tool mounting member into a first portion comprising the tool interface and a second portion positioned closer to the proximate end than the first portion. The first sleeve is configured to receive the collaborative robot, and to sealably couple with a port of the glovebox at a proximate end of the sleeve, and to the mounting surface. The first sleeve configured to cover the second portion of the mounting surface.

### CROSS REFERENCE TO RELATED APPLICATION AND CLAIM OF PRIORITY

The present application claims priority to U.S. provisional patent application no. 63/504,788 filed on May 29, 2023, the entire contents of which are hereby incorporated by reference.

### TECHNICAL FIELD

The present disclosure generally relates to handling hazardous materials and in particular to gloveboxes.

### BACKGROUND

A glovebox is a sealed container that allows a user to manipulate object(s) in a separate atmosphere. Typical gloveboxes are arranged such that a user can place their hands into gloves and handle material (e.g. hazardous material), without breaking containment. However, during use, the gloves may be punctured, ruptured, tear, or otherwise be damaged, resulting in a loss of containment of the hazardous materials.

### SUMMARY

In an aspect, a system for deploying a collaborative robot in a glovebox is provided. The system comprises: a collaborative robot having a proximate end and a distal end, the proximate end mounted to a collaborative robot mount, and the distal end comprising a tool mounting member, the tool mounting member comprising a tool interface for coupling to an end effector, and a mounting surface for coupling to a first sleeve, the mounting surface dividing a total surface of the tool mounting member into a first portion comprising the tool interface and a second portion positioned closer to the proximate end than the first portion; and the first sleeve having a proximate end and a distal end, the first sleeve configured to receive the collaborative robot, and to sealably couple with a port of the glovebox at the proximate end of the sleeve, and to sealably couple with the mounting surface at the distal end of the first sleeve, the first sleeve configured to cover the second portion of the mounting surface.

In an embodiment, an end effector coupled to the tool interface.

In an embodiment, the end effector extends from the tool interface, and wherein the collaborative robot is substantially covered by the first sleeve and the end effector is not covered by the first sleeve.

In an embodiment, the tool interface is configured to couple to a plurality of different end effectors.

In an embodiment, the mounting surface comprises grooves extending around a perimeter of the tool interface, the grooves configured to form a seal with o-rings of the first sleeve.

In an embodiment, the end effector is detachably coupled to the tool interface.

In an embodiment, the collaborative robot comprises a robot head having a robot interface for coupling to the tool interface, the robot interface having power and control connections for coupling with the tool interface to provide power and control instructions to the end effector. The robot interface may be configured to detach from the tool mounting member.

In an embodiment, the system comprises a controller configured to control the movement of the collaborative robot. The controller may be configured to receive and send signals to the collaborative robot.

In an embodiment, the system comprises a stand for positioning inside the glovebox, the stand comprising members to position an interface of the end effector in a substantially upward orientation when the end effector is uncoupled from the collaborative robot.

In an embodiment, the system comprises a second sleeve for coupling to the port of the glovebox and to the collaborative robot, the second sleeve configured to be positioned to define a portion of the collaborative robot outside of the glovebox, wherein the first sleeve, the second sleeve, and the collaborative robot define a sealed volume of space. The system may comprises a pump for pressurizing the sealed volume of space to a first pressure greater than second pressure of the glovebox.

Embodiments may include combinations of the above features.

In another aspect, a system for maintaining separation between a first atmosphere outside a glovebox and a second atmosphere inside the glovebox is provided. The system comprises: a collaborative robot having a proximate end and a distal end, the proximate end mounted to a collaborative robot mount; a first sleeve having a proximate end and a distal end, the first sleeve configured to receive the collaborative robot, and to sealably couple with a port of the glovebox at the proximate end of the sleeve; and a second sleeve for coupling to the port of the glovebox and to the collaborative robot, the second sleeve configured to define a portion of the collaborative robot outside of the glovebox. The first sleeve, the second sleeve, and the collaborative robot define a sealed volume of space.

In an embodiment, the first sleeve is coupled to the distal end of the collaborative robot, and wherein the first sleeve is configured to define a first portion of the sealed volume, the first portion of the sealed volume defined between the first sleeve and the collaborative robot.

In an embodiment, the first sleeve defines the distal end of the collaborative robot within the first sleeve.

In an embodiment, the system comprises a pump for pressurizing the sealed volume of space to a first pressure greater than second pressure of the glovebox. The system may comprises a high-efficiency particulate absorbing (HEPA) filter for filtering air entering or existing the sealed volume of space.

Embodiments may include combinations of the above features.

In another aspect, a method of deploying a collaborative robot in a glovebox is provided. The method comprises: coupling a proximal end of a first sleeve to a port of the glovebox with an fastener; inverting the first sleeve to position the first sleeve extending from the port toward an exterior of the glovebox; mounting the collaborative robot on a collaborative robot mount: extending the collaborative robot into a generally horizontal position such that its cross-section projects within a circumference of the port; coupling a distal end of the inverted first sleeve to an mounting surface of the collaborative robot for forming a first seal; receiving the collaborative robot in the first sleeve, the first sleeve configured to define the external surface of the collaborative robot within the sleeve; inserting the collaborative robot through a port, and into an inner volume, of the glovebox; forming a second seal between the first sleeve and the port to prevent contaminants from migrating between an inner volume of the glovebox and the collaborative robot.

In an embodiment, the method comprises coupling the tool mounting member to an end effector inside the glovebox.

In an embodiment, a glove is secured to port of the glovebox with an o-ring, the method comprising positioning the glove on a first o-ring groove of the port, positioning the first sleeve on a second o-ring groove of the port, and disconnecting the glove from the first o-ring groove.

In an embodiment, the method comprises forming a seal between a second sleeve and the port of the glove box, and forming a seal between the second sleeve and the collaborative robot, wherein the second sleeve defines a portion of the first sleeve and the collaborative robot outside the glove box, wherein the first sleeve, the second sleeve, and the collaborative robot define a sealed volume of space.

In an embodiment, the method comprises flowing air into a sealed volume of space defined by the first sleeve, the second sleeve, and the collaborative robot.

In an embodiment, the method comprises filtering the air with a HEPA filter.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 shows a schematic view of a system for deploying a collaborative robot in a glovebox;

FIGS. 2A and 2B show exploded and assembled views respectively of an example collaborative robot;

FIG. 3A shows a front perspective view of an example tool mounting member having a mounting surface for a sleeve. FIG. 3B shows a rear perspective view of the example tool mounting member of FIG. 3A;

FIG. 4A shows a perspective view of a distal side of robot interface. FIG. 4B shows a perspective view of a proximal side of the robot interface of FIG. 4A;

FIG. 5 shows a plan view of an example primary sleeve;

FIG. 6A shows a plan view of an example secondary sleeve and FIG. 6B shows a cross-sectional view of secondary sleeve along the line C-C shown in FIG. 6A;

FIG. 7 shows an image of collaborative robot deployed in glovebox;

FIG. 8A shows a perspective view of an example collaborative robot mount and FIG. 8B illustrates a cross-sectional view of an inner and outer race of the collaborative robot mount along line B-B in FIG. 8A;

FIGS. 9A and 9B illustrates images of collaborative robot deployed in a glovebox;

FIG. 10 is schematic diagram illustrating an example method of deploying a collaborative robot in a glovebox;

FIG. 11 is a schematic diagram of a controller 1100 for controlling the operation of a collaborative robot according to this disclosure.

### DETAILED DESCRIPTION

An aspect of this disclosure is to provide a system for deploy a collaborative robot, e.g. a robotic arm, into a glovebox without breaking containment. Embodiments of the system have been developed to deploy (insert and withdraw) a collaborative robot into an (e.g., alpha) glovebox on a nuclear licensed site. An objective is to augment existing glovebox operations with a collaborative robot leading to significant risk reduction in comparison to manual operations, i.e. a human inserting they arms into gloves to perform tasks in a glovebox. While developed for the nuclear sector, the operations in gloveboxes are common across many industrial and chemical operations where workers currently conduct operations manually. In the nuclear industry there are significant radiological risks to manual workers associated with manual working in gloveboxes. Currently operations in gloveboxes are generally undertaken by manual workers. These operations may typically be carried out via 6″ (152 mm) glove ports that have a Hypalon glove providing containment. Two example types of glove ports include: (1) Harwell type, featuring a spigot to host a double o-ring arrangement; (2) CRL Push Through glove port. Typically 8″ (205 mm) and 10″ (254 mm) ports are bagging ports used to post waste out of the glovebox. These arrangements are typical across both the nuclear industry and the wider chemical and pharmaceutical industries. Systems for deploying a collaborative robot in a glovebox according to this disclosure may be configured to couple to the glove ports of existing gloveboxes so that they may be retrofitted with the systems of this disclosure.

Aspects of the present description provide systems for deploying a collaborative robot in a glovebox. The system may be developed to deploy a collaborative robot (i.e. a robotic arm) into a glovebox (e.g. an alpha glovebox) on a nuclear licensed site. The system may be implemented to augment an existing glovebox with a collaborative robot which may reduce the risk of accidental exposure to material in the glovebox as a user is not required to manually reach into the glovebox. The system may reduce risk to operators of gloveboxes by providing a remote system that will substitute a physical human interaction in the glovebox with a robotic twin of the operator. The system may be controlled remotely which may mitigate exposure risk to users when the content of a glove box contain hazardous material, e.g. material that gives off gamma radiation, which is potentially hazardous to a user even when contained in a glovebox.

Patent Cooperation Treaty (PCT) International Application No. PCT/IB2020/058708 (Published as WO2021/053598A1), filed Sep. 18, 2020, entitled “System and Method for Deploying a Collaborative Robot in a Glovebox”, the entirety of which is hereby incorporated by reference, discloses an example systems for deploying collaborative robots in a glovebox. This system may utilize a sleeve around the entire collaborative robot including the end effector which necessitates removing the collaborative robot from the sleeve and glovebox to change the end effector with another tool. Successively removing the collaborative robot from a glovebox to change the tool of the end effector, and reinserting the collaborative robot into the glovebox, may delay work and increase risk of damaging (e.g tearing) the sleeve. Aspects of systems for deploying a collaborative robot in a glovebox according to this disclosure may resolve this disclosure by utilizing a detachable end effector, which may be stored within the glove box when not in use, the detachable end effector extending from a tool mounting member of the collaborative robot. A sleeve may be positioned around the collaborative robot and sealable coupled to the collaborative robot, e.g. a Kinova™ arm, proximate to the tool mounting member such that a portion of the collaborative robot up-the-sleeve is separated from the internal environment of the glovebox. The sleeve may be sealably coupled to the collaborative robot at a mounting surface configured to receive the distal end of the sleeve around a circumference of the collaborative robot. This arrangement may allow end effectors to be swapped within the glovebox which saves time and reduces the risk of damaging the sleeve as the collaborative robot arm does not need to be pulled from the sleeve and glovebox when the end effector is changed.

Systems and methods described in this disclosure may address various challenges and/or limitations present in existing glovebox systems. For example, the use of a robotics gives many advantages over a human operator, e.g.: reduced injury risk (nuclear safety), greater reach and handling strength, reduced injury risk (poor ergonomics), precise control, repeatable routines. Systems and methods according to this disclosure may also retrofit a robotic arm to (or into) an existing glovebox while maintaining a seal and separate atmosphere within the glovebox.

While embodiments of the invention are described in relation to nuclear technology, the example systems, methods and/or devices described herein may be adapted and/or implemented for use in any glovebox used in research, industrial, pharmaceutical, and/or chemical operations. In some embodiments, the example systems, methods and/or devices described herein may be adapted and/or implemented for use in any application or environment where it may be beneficial to physically isolate/insulate a human operator from objects being manipulated and/or the environment in which those objects are situated.

### DEFINITIONS

Although terms such as “maximize”, “minimize” and “optimize” may be used in the present disclosure, it should be understood that such term may be used to refer to improvements, tuning and refinements which may not be strictly limited to maximal, minimal or optimal.

The term “connected” or “coupled to” may include both direct coupling (in which two elements that are coupled to each other contact each other) and indirect coupling (in which at least one additional element is located between the two elements).

The term “substantially” as used herein may be applied to modify any quantitative representation which could permissibly vary without resulting in a change in the basic function to which it is related.

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

Aspects of various embodiments are described through reference to the drawings.

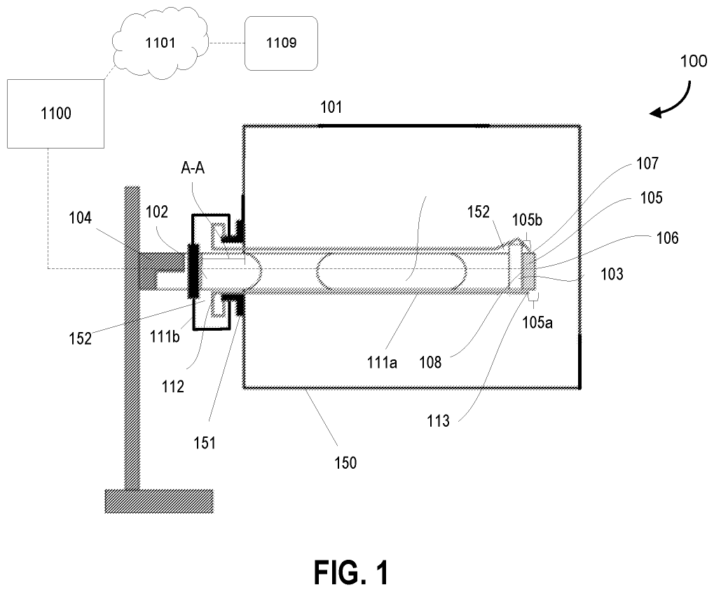

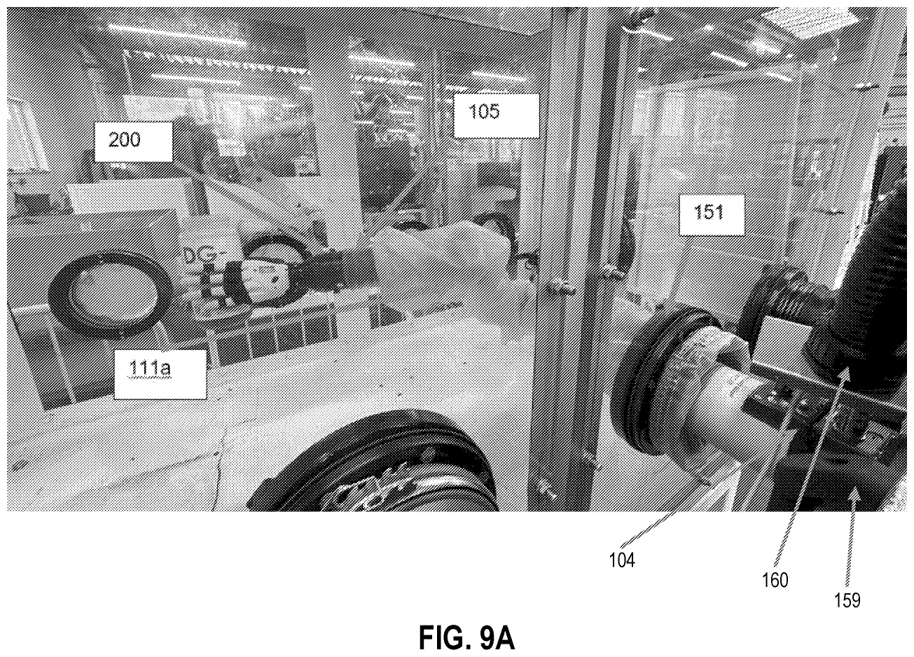

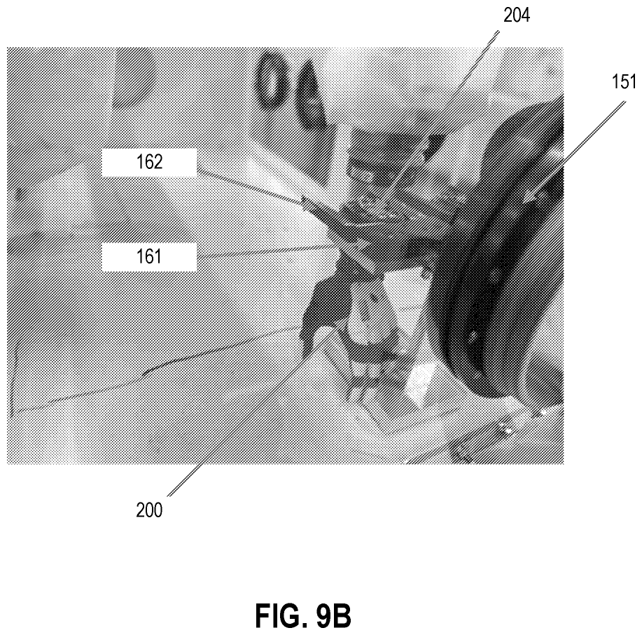

FIG. 1 illustrates a system 100 for deploying a collaborative robot 101, e.g. a Kinova™ arm, in a glovebox 150. System 100 comprises collaborative robot 101 which has a proximate end 102 and a distal end 103. Proximate end 102 of collaborate robot 101 may be mounted to a collaborative robot mount 104. Distal end 103 may comprises a tool mounting member 105 which comprises a tool interface 106 for coupling to an end effector (shown in FIGS. 9A and 9B). Mounting surface 107 is provided for coupling to a first sleeve 111a, also referred to herein as a primary sleeve. First sleeve 111a may be made from Poly Vinyl Chloride “PVC” (e.g. 300 μm PVC) or other suitable material for glovebox service. A mounting surface 107 may divide a total surface of the tool mounting member 105 into a first portion 105a comprising the tool interface 106 and a second portion 105b positioned closer to proximate end 102 than first portion 105a. First sleeve 111a has a proximate end 112 and a distal end 113, where first sleeve 111a may be configured to receive collaborative robot 101, and to sealably couple with a port 151 of glovebox 150 at proximate end 112 of sleeve 111a, and to sealably couple with mounting surface 107 at distal end 113 of first sleeve 111. First sleeve 111a may be configured to cover second portion 105b of the mounting surface 107. As described below, an end effector 200 may be releasably coupled to the tool interface 106 to allow end effectors to be exchanged, e.g. within the glovebox without having to withdraw the collaborative robot from sleeve 111a and/or glovebox 150.

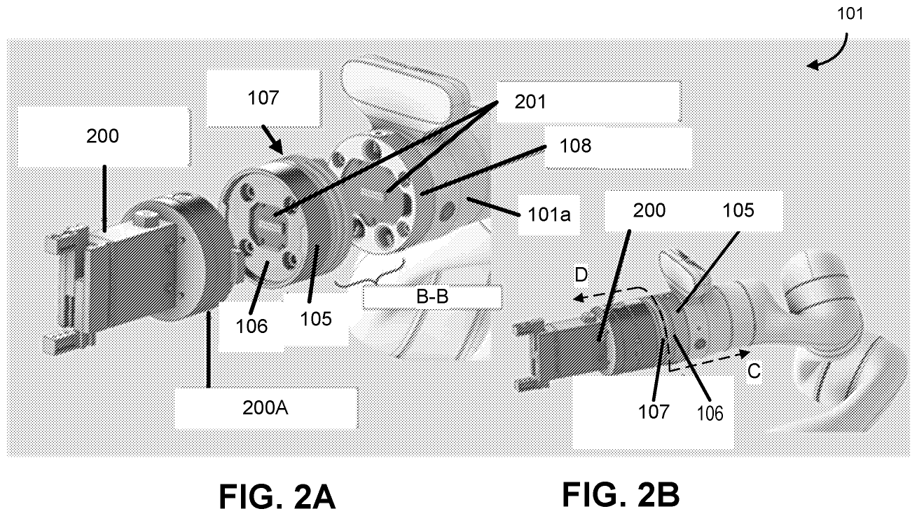

FIGS. 2A and 2B illustrates exploded and assembled views respectively of an example collaborative robot 101 according to this disclosure. In the illustrated example, a modified Kinova™ arm is shown. End effector 200 may extend from tool interface 106 of tool mounting member 105 which may have a releasable coupling mechanism such an electromagnet, clasp, clamp, co-bot tool changer, etc. to permit releasable coupling between effector 200 and tool interface 106. A power/control connection 201 may be provided on tool mounting member 105 and robot interface 108 to communicate power and/or control data to end effector 200. Tool mounting member 105 may be coupled or uncoupled from a body 101a of collaborative robot 101 at robot interface 108 by relative movement along line B-B. As shown, tool mounting member 105 and robot head interface 10 may have alignment features to assist in a desired alignment and coupling between the elements. Alignment feature may also prevent relative rotation of the tool mounting member 105 and robot interface 108. As described below, collaborative robot 101 may be substantially covered by first sleeve 111a and end effector 200 may not be covered by first sleeve 111a. For example, a distal end of sleeve 111a may couple to mounting surface 107 such that sleeve 111a defines the portion of collaborative robot 101 from mounting surface 107 up-the-sleeve to the port 151 of the glovebox 150. When sleeve 111a is coupled to mounting surface 107, arrow D indicates the portion of the collaborative robot 101 and end effector 200 that is positioned for dirty service within the glovebox, and arrow C indicates the portion of the collaborative robot 101 that is positioned for clean service within sleeve 111a.

In an embodiment, tool interface 106 is configured to couple to a plurality of different end effectors. As illustrated in FIGS. 2A and 2B a zimmer gripper end effector is shown; however, this disclosure is not limited to any one type of end effector. End effectors comprising any of grippers, process tools, and/or sensors may be coupled to collaborative robot 101 to perform a task within the glovebox.

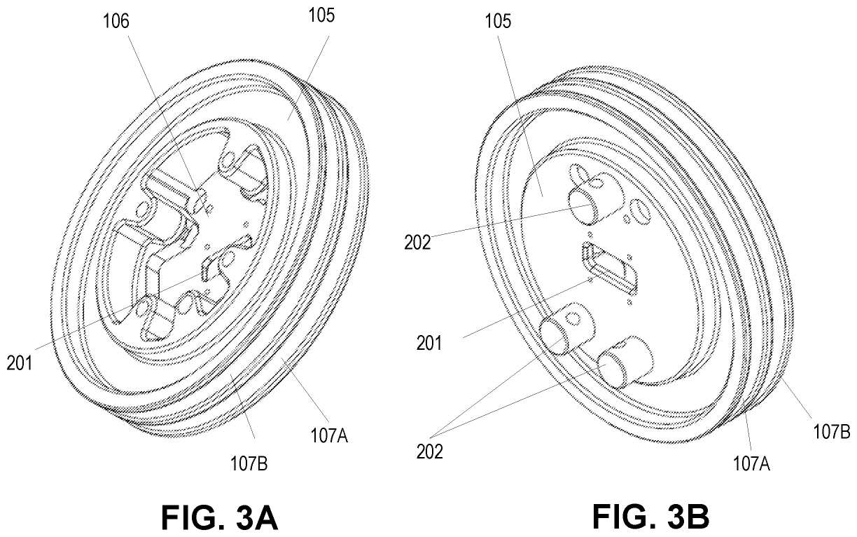

FIGS. 3A and 3B illustrate an example tool mounting member 105 having a mounting surface 107 according to this disclosure. Tool mounting member 105 may be detachable from end effector 200 and/or robot interface 108. FIG. 3A illustrates a perspective view of a distal side of tool mounting member 105 showing interface 106; and FIG. 3B illustrates a perspective view of a proximal side of tool mounting member 105. As shown, mounting surface 107 may comprise grooves 107a extending around a perimeter of the tool mounting member 105 to receive a distal end of sleeve 111a. Grooves 107a may be configured to form a seal with sleeve 111a using a fastener, e.g. o-rings and/or clamps, to couple sleeve 111a to grooves 107A, 107B. Grooves 107A, 107B may comprise a first and second groove for sealing sleeve 111a at either the first or second groove. Grooves 107A, 107B may extend around the circumference of tool mounting member 105, and may assist a replacement first sleeve 111a to be coupled to mounting surface 107 while maintaining containment of the environment inside glovebox 150. A power/control connection 201 may be provided on tool mounting member 105 to communicate power and/or date from robot interface 108 to end effector 200. In another embodiment, tool mounting member 105 may define an opening through which power/control connection 201 of robot interface 108 may connect to end effector 200. A plurality of pins 202 may be positioned tool mounting member 105 to provide alignment with robot interface 108, e.g. to align power/control connection 201 with a corresponding port of the end effector. Interface 106 may be shaped to receive and detachably couple to end effector 200. In an example, interface 106 comprises a co-bot tool changer 200A for automatic docking/releasing of a range of tools to couple with collaborative robot 101.

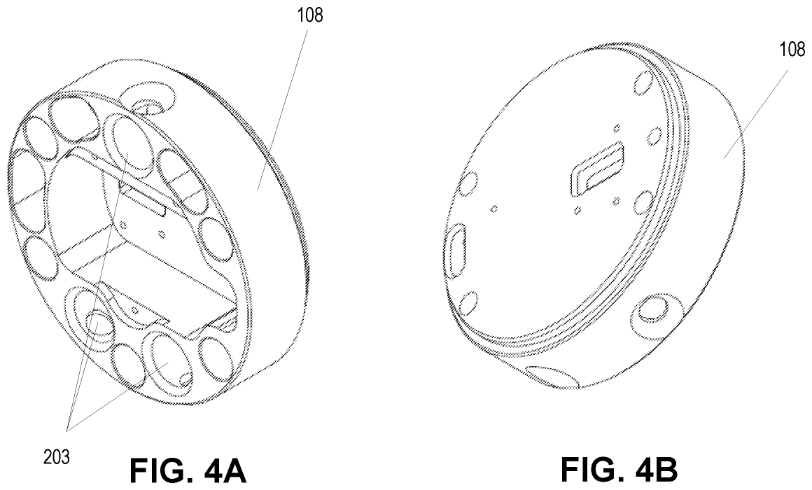

FIGS. 4A and 4B illustrate an example robot interface 108 according to this disclosure which may be configured to couple to the tool interface according to this disclosure. FIG. 4A illustrates a perspective view of a distal side of robot interface 108 showing ports 203 for receiving pins 202 to align power/control connection 201 for coupling power/control data (e.g. instructions) to end effector 200. FIG. 4B illustrates a perspective view of a proximal side of robot interface 108 which is configured to be connected to a wrist of collaborative robot 101. In some embodiments, robot interface 108 is configured to detach from tool mounting member 105.

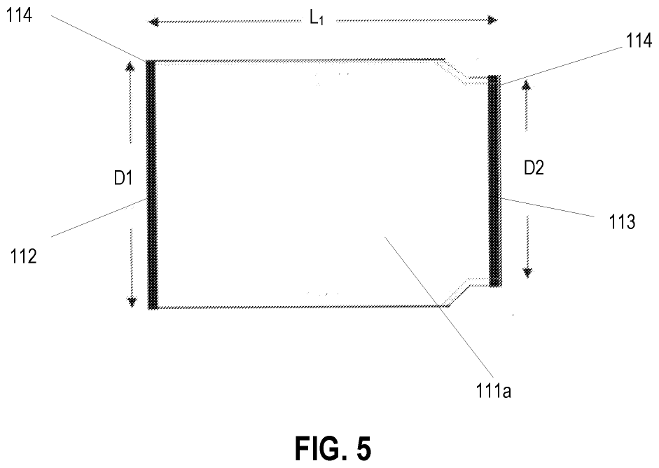

FIG. 5 illustrates a plan view of an example first sleeve 111a according to this disclosure. Sleeve 111a may have a proximate end 112 and a distal end 113. First sleeve 111a may be configured to receive collaborative robot 101 and to sealably couple with a port of glovebox 150 at proximate end 112 of sleeve 111a, and to sealably couple with mounting surface 107 of the collaborative robot 101 at distal end 113 of first sleeve 111. To facilitate coupling of sleeve 111a to mounting surface 107 and port 151, sleeve 111a may comprise fasteners 114, e.g. o-rings, magnetic seals, bands, or the like, at each of proximate end 112 and distal end 113. In other embodiments, fasteners 115 may be separate from sleeve 111a. As shown in FIG. 5, the diameter D1 of the opening of sleeve 111a a proximate end 112 may be larger than the diameter D2 at distal end 113 of sleeve 111a to reduce excess sleeve material near the end effector which may get damaged during operation of collaborative robot 101 within the glovebox. Length L1 of sleeve 111a, in an example, may be configured to be at least the extended length from port 151 to mounting surface 107 when collaborative robot 101 is fully extended.

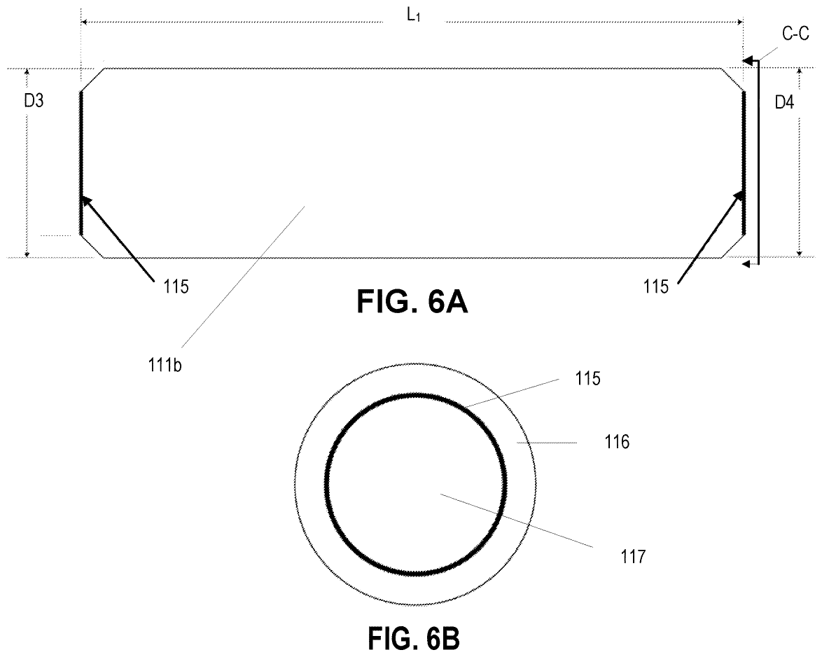

FIG. 6A illustrates a plan view of an example second sleeve 111b according to this disclosure. In an aspect, second sleeve 111b may provide a redudancy for first sleeve 111a to prevent a loss of containment, e.g. if first sleeve is rips, tears, or the fasteners at the distal or proximate ends dislodge. Second sleeve 111b may be made of PVC (e.g. 300 μm or 375 μm PVC) or other suitable material for glovebox service. Second sleeve 111b may couple to both port 151 of glovebox 150 and to collaborative robot 101. Second sleeve 111b may be configured to be positioned to define a portion A-A of the collaborative robot outside of the glovebox, where first sleeve 111a, second sleeve 111b, and collaborative robot 101 define a sealed volume of space 152 shown in FIG. 1. As shown in FIG. 6A, the diameters D3, D4 of the openings of sleeve 111a may be approximately the same. Length L2 of sleeve 111b, in an example, may be configured to be at least the extended length from port 151 to mounting surface 107 when collaborative robot 101 is fully extended. To facilitate coupling of sleeve 111a to port 151 and collaborative robot mount 104, sleeve 111b may comprise fasteners 115, e.g. o-rings, magnetic seals, bands, or the like, at each end of sleeve 111b. FIG. 6B illustrates a cross-sectional view of second sleeve 111b along the line C-C shown in FIG. 6A. Second sleeve 111b may have a tapered shoulder 116 at one or both ends of second sleeved 111b. Openings 117 may be defined by the second sleeve 111b at the opposing ends of the second sleeve 111b. Fasteners 115 may be positioned at or near the opposing ends of the second sleeve 111b for coupling to port 151 and/or collaborative robot mount 104.

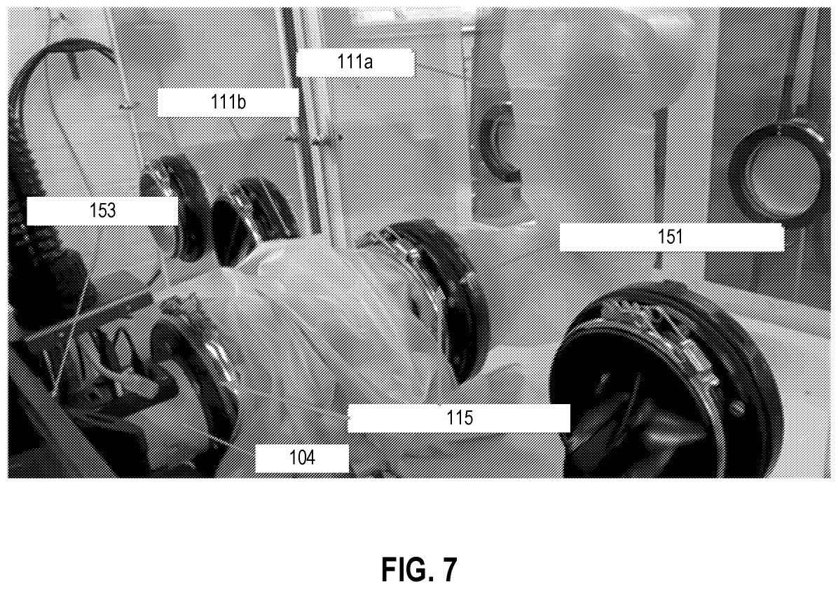

FIG. 7 illustrates an image of collaborative robot 101 deployed in glovebox 150. Deployment base 153 may be a stand supporting collaborative robot 101 for positioning the collaborative robot 101 into alignment with port 151. First sleeve 111a and second sleeve 111b are coupled to glovebox 150 at opposing sides of port 151 by fasteners 115.

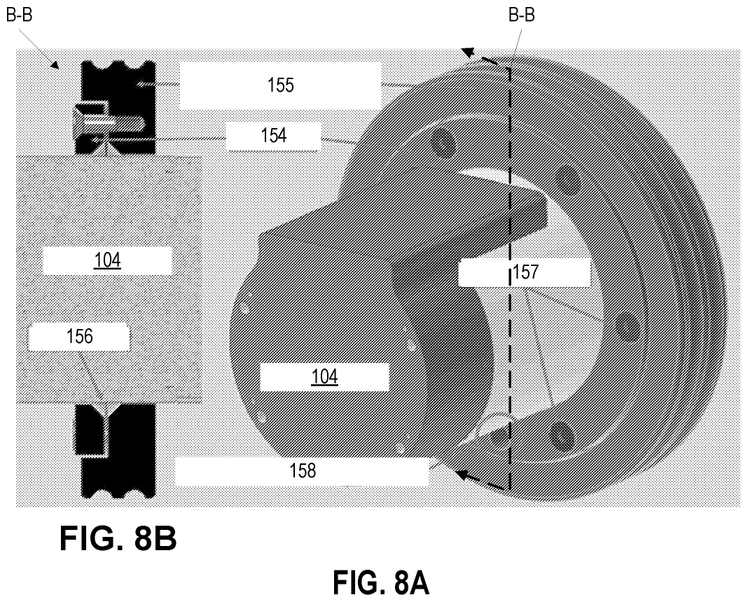

FIG. 8A illustrates a perspective view of an example collaborative robot mount 104 and FIG. 8B illustrates a cross-sectional view of an inner and outer race of the collaborative robot mount 104 along line B-B in FIG. 8A. Collaborative robot mount 104 is configured to receive an arm of collaborative robot 101. Mount 104 may comprise power and/or data connections for communicating power and/or data to collaborative robot 101 and end effector 200 to perform desired tasks within glovebox 150. Mount 104 may comprise an inner race 154 and an outer race 155 for coupling to second sleeve 111b. An end of second sleeve 111b may be positioned in cavity 156 to partially define inner race 154. Fasteners 157, e.g. screws, may force inner race 154 toward outer race 155 fixing an end of sleeve 111b between inner race 154 and outer race 155. Inner race 154 may defined an opening 158 in a surface of inner race 154 which is in fluid communication with the sealed volume of space 152. Opening 158 may be in fluid communication with a pump 159 for pressurizing the sealed volume of space 152 to a first pressure greater than second pressure of the glovebox. Filter 160, shown in FIG. 9A, e.g. a high-efficiency particulate absorbing (HEPA) filter, may also be in fluid communication with opening 158 for filtering air circulated by pump 159 entering or existing the sealed volume of space 152.

FIGS. 9A and 9B illustrates an image of collaborative robot 101 deployed in a glovebox. As shown in FIG. 9A, end effector 200 may be a robotic hand or similar end effector used to grip objects within glove box 150. FIG. 9B illustrates a stand 161 for positioning inside glovebox 150. Stand 161 may comprises members 162 to position an interface 204 of the end effector 200 in a substantially upward orientation when end effector is uncoupled from collaborative robot 101. Placement of interface 204 in a substantially upward orientation may permit easier coupling between end effector 200, e.g. via co-bot tool changer 200A, and tool mounting member 105 of collaborative robot 101.

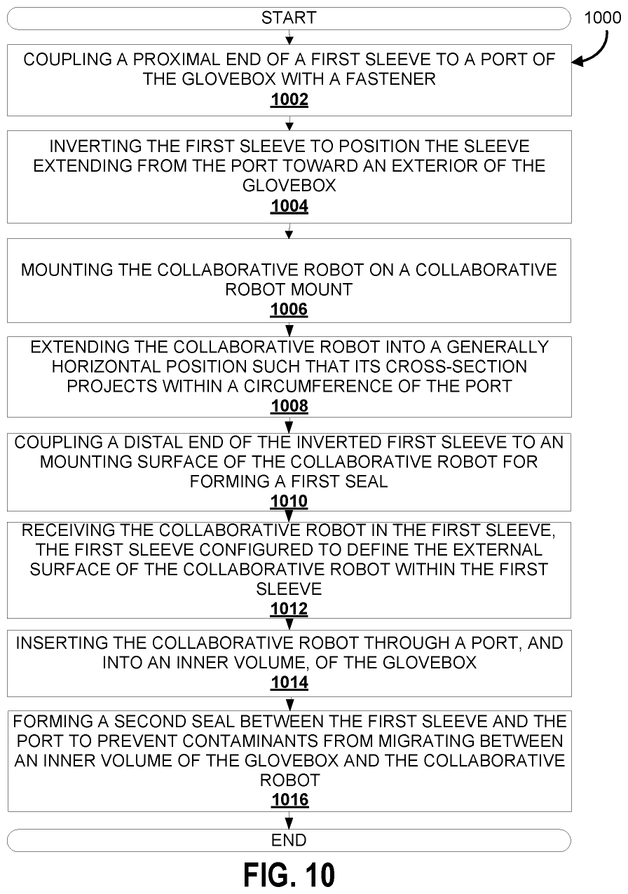

FIG. 10 is schematic diagram illustrating an example method 1000 of deploying a collaborative robot in a glovebox. In an example, the collaborative robot 101 and glovebox 150 described above may be used to perform method 1000 to deploy the collaborative robot 101 in glovebox 150. In an embodiment, method 1000 may retrofit an existing previouly used glovebox no demand to disconnect the glovebox and relocate it. The glovebox ventilation system may be live at all times within the glovebox which may include a Vortex Amplifier (VXA) system (an automatic breach mitigation system), or equivalent capability. Method 1000 may also substitute a glove (hand) in the glovebox with a collaborative robot while maintaining containment of that environment within the glovebox.

At 1002, the method 1000 comprises coupling a proximal end of a first sleeve 111a to port 151 of glovebox 150 with a fastener, e.g. an O-ring, band, magnetic seal, or the like.

At 1004, first sleeve 111a may be inverted to position sleeve 111a to extend from the port toward an exterior of the glovebox. Distal end 113 may then be positioned outside glovebox 150 for coupling to distal end 103 of the collaborative robot 101 at mounting surface 107 near the wrist of collaborative robot 101.

At 1006, collaborative robot 101 may be mounted on a collaborative robot mount 104. Power control connection 201 may be connected to robot mount 104 and/or controller 1100 to control and power collaborative robot 101.

At 1008, collaborative robot 101 may be extended into a generally horizontal position such that its cross-section projects within a circumference of port 151. Positioning collaborative robot 101 in the horizonal position may occur at any point during this method.

At 1010, a distal end 113 of the inverted first sleeve 111a may be coupled to mounting surface 107 of collaborative robot 101 for forming a first seal.

At 1012, collaborative robot 101 may be received in sleeve 111a. Initially, first sleeve 111a may be inverted and distal end 113 of first sleeve may be coupled to mounting surface 107 near distal end 103 of collaborative robot. Collaborative robot 101 may then be advanced into sleeve 111a. First sleeve 111a may be configured to define the external surface of collaborative robot 101 within the first sleeve 111a. First sleeve 111a may have a length L1 at least equal to or greater than an extended length of collaborative robot 101. In an example, length L1 may be 5-30% greater than the extended length of collaborative robot 101 to reduce the risk or stretching and/or tearing the material of the first sleeve 111a.

At 1014, collaborative robot 101 may be inserted through port 151, and into an inner volume, of glovebox 150. In an example, as collaborative robot 101 is inserted through port 151 the second portion 105b of tool interface 106 and the portion of collaborative robot 101 up-sleeve from the second portion 105b is defined by, i.e. covered by, first sleeve 111a. “Up-sleeve” may mean the portion of collaborative robot 101 from mounting surface 107 to mount 104. First portion 105a of tool interface 106 may be exposed to the environment within glovebox 150.

At 1016, a second seal may be formed between first sleeve 111a the port 151 to prevent contaminants from migrating between an inner volume of glovebox 150 to second portion 105b of tool interface 106 and collaborative robot 101 up-sleeve from the second portion 105b. In an embodiment, a seal between second sleeve 111b and port 151 of glovebox 150 may be formed; and another seal may be formed between second sleeve 111b and collaborative robot 101 e.g. at mount 104. In an example, the other seal between second sleeve 111b and collaborative robot 101 may be formed between inner race 154 and outer race 155. Second sleeve 111b may define a portion of first sleeve 111a and collaborative robot 101 outside the glove box 150, where first sleeve 111a, second sleeve 111b, and collaborative robot 101 define a sealed volume of space 152.

Once collaborative robot 101 is deployed within glovebox 101, method 1000 may comprise coupling tool mounting member 105 to an end effector 200 inside glovebox 150. End effector 200 may then be controlled by controller 1100 to perform task within glovebox 150.

In an embodiment, initially, before glovebox 150 is retrofitted with collaborative robot 101, a glove may be secured to a port of the glovebox with a fastener, e.g. an o-ring. The glove may be any glovebox glove such as an Econoline™ glove Model #3JT05. Method 1000 may comprise positioning the glove on a first o-ring groove of the port, positioning the first sleeve 111a on a second o-ring groove of the port, and disconnecting the glove from the first o-ring groove. This may prevent loss of containment of the environment within glovebox 150.

In an embodiment, gas (e.g. air) is flowed into sealed volume of space 152 defined by first sleeve 111a, second sleeve 111b, and the collaborative robot 101 which may allow the pressure within the sealed volume of space 152 to be greater than a pressure inside glovebox 150. This may mitigate against loss of containment in the event of damage to first sleeve 111a the pressurized gas within sealed volume of space 152 would flow into glovebox 150. The gas may be pumped into sealed volume of space 152 through opening 158. In another embodiment, a HEPA filter may filter the gas entering or leaving glovebox 150.

Removal of collaborative robot 101 from glovebox 150 may be achieved by withdrawing the collaborative robot 101 through port 151. In an embodiment, tool mounting member 105 may be uncoupled from body 101a of collaborative robot 101 before or after body 101a is withdrawn through port 151. Second sleeve 111b may be uncoupled from port 151 to permit access to body 101a of collaborative robot 101 for maintenance or other desired tasks to be performed. Because first sleeve 111a remains coupled to tool mounting member 105, the internal environment of glovebox 150 may remain sealed from the external environment of glovebox 150.

In another embodiment, collaborative robot 101 may be removed from glovebox 150 while tool mounting member 105 is attached to body 101a. Second sleeve 111b may be uncoupled from port 151 to permit access to body 101a of collaborative robot 101 First sleeve 111a may be inverted a body 101a and tool mounting member 105 are withdrawn from port 151 and are outside glovebox 150. First sleeve 111a may be welded between ends 112, 113 to create a seal. First sleeve 111a may then be cut between tool mounting member 105 and the weld to uncouple collaborative robot 101 from glovebox 150.

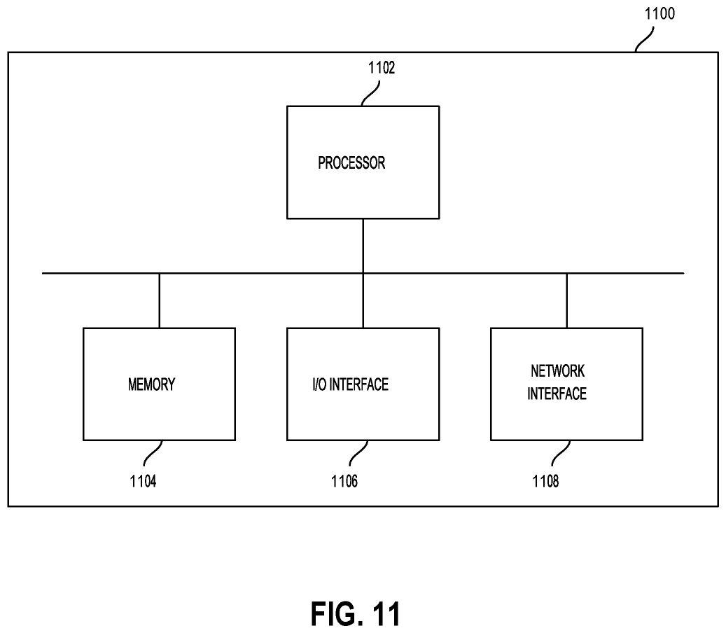

FIG. 11 is a schematic diagram of a controller 1100. In some embodiments, the controller can be or can include a computer or other computing device. As depicted, the an example computing device includes at least one processor 1102, memory 1104, at least one I/O interface 1106, and at least one network interface 1108. In an embodiment, system 100 comprises controller 1100 configured to control the movement of collaborative robot 101 and end effector 200. Controller 1100 may be configured to receive and send data to and from the collaborative robot and/or the end effector.

Processor 1102 may be an Intel or AMD x86 or x64, PowerPC, ARM processor, or the like. Memory 1104 may include a combination of computer memory that is located either internally or externally such as, for example, random-access memory (RAM), read-only memory (ROM), compact disc read-only memory (CDROM). Each I/O interface 1106 enables controller 1100 to interconnect with one or more input devices, such as input device/controller, a keyboard, mouse, camera, touch screen and a microphone, or with one or more output devices such as a display screen and a speaker. In some embodiments, the I/O interface 1105 provides an interface for sending and/or receiving signals (such as control, feedback, position and/or sensor signals and/or the like) to collaborative robot 101 and/or end effector 200.

Each network interface 1108 enables controller 1100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others. In embodiments, the network interface 1108 enables the controller 1100 to communicate over Bluetooth™, RF, and/or any other radio-based or other wireless communication protocol 1101 with other components (e.g. monitors, controller, collaborative robot, cameras, etc.). Controller 1100, in some embodiments, may communicate, via network 1101, with a remote controller 1109 to control collaborative robot 101 and/or end effector 200.

Enabling remote operations may improving operator safety as a safety risk may be caused by being dosed from being in proximity with radioactive material and also manipulating sharp objects that can puncture the glove of a traditional glovebox.

### Alternate Embodiments

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus- or step-plus-function limitations, unless such a limitation is explicitly recited in a given claim using the phrase(s) “means for” or “step for,” respectively.

1. A system for deploying a collaborative robot in a glovebox, the system comprising:
a collaborative robot having a proximate end and a distal end, the proximate end mounted to a collaborative robot mount, and the distal end comprising a tool mounting member, the tool mounting member comprising a tool interface for coupling to an end effector, and a mounting surface for coupling to a first sleeve, the mounting surface dividing a total surface of the tool mounting member into a first portion comprising the tool interface and a second portion positioned closer to the proximate end than the first portion; and
the first sleeve having a proximate end and a distal end, the first sleeve configured to receive the collaborative robot, and to sealably couple with a port of the glovebox at the proximate end of the sleeve, and to sealably couple with the mounting surface at the distal end of the first sleeve, the first sleeve configured to cover the second portion of the mounting surface.

2. The system of claim 1, comprising an end effector coupled to the tool interface.

3. The system of claim 1, wherein the end effector extends from the tool interface, and wherein the collaborative robot is substantially covered by the first sleeve and the end effector is not covered by the first sleeve.

4. The system of claim 1, wherein the tool interface is configured to couple to a plurality of different end effectors.

5. The system of claim 1, wherein the mounting surface comprises grooves extending around a perimeter of the tool interface, the grooves configured to form a seal with o-rings of the first sleeve.

6. The system of claim 1, wherein the end effector is detachably coupled to the tool interface.

7. The system of claim 1, wherein the collaborative robot comprises a robot head having a robot interface for coupling to the tool interface, the robot interface having power and control connections for coupling with the tool interface to provide power and control instructions to the end effector.

8. The system of claim 7, wherein the robot interface is configured to detached from the tool mounting member.

9-11. (canceled)

12. The system of claim 1, comprising a second sleeve for coupling to the port of the glovebox and to the collaborative robot, the second sleeve configured to be positioned to define a portion of the collaborative robot outside of the glovebox, wherein the first sleeve, the second sleeve, and the collaborative robot define a sealed volume of space, wherein the system comprises a pump for pressurizing the sealed volume of space to a first pressure greater than a second pressure of the glovebox.

13. (canceled)

14. A system for maintaining separation between a first atmosphere outside a glovebox and a second atmosphere inside the glovebox, the system comprising:
a collaborative robot having a proximate end and a distal end, the proximate end mounted to a collaborative robot mount;
a first sleeve having a proximate end and a distal end, the first sleeve configured to receive the collaborative robot, and to sealably couple with a port of the glovebox at the proximate end of the sleeve; and
a second sleeve for coupling to the port of the glovebox and to the collaborative robot, the second sleeve configured to define a portion of the collaborative robot outside of the glovebox;
wherein the first sleeve, the second sleeve, and the collaborative robot define a sealed volume of space.

15. The system of claim 14, wherein the first sleeve is coupled to the distal end of the collaborative robot, and wherein the first sleeve is configured to define a first portion of the sealed volume, the first portion of the sealed volume defined between the first sleeve and the collaborative robot.

16. The system of claim 14, wherein the first sleeve defines the distal end of the collaborative robot within the first sleeve.

17. The system of claim 14, comprising a pump for pressurizing the sealed volume of space to a first pressure greater than second pressure of the glovebox.

18. The system of claim 17, comprising a high-efficiency particulate absorbing (HEPA) filter for filtering air entering or existing the sealed volume of space.

19. A method of deploying a collaborative robot in a glovebox, the method comprising:
coupling a proximal end of a first sleeve to a port of the glovebox with an fastener;
inverting the first sleeve to position the first sleeve extending from the port toward an exterior of the glovebox;
mounting the collaborative robot on a collaborative robot mount:
extending the collaborative robot into a generally horizontal position such that its cross-section projects within a circumference of the port;
coupling a distal end of the inverted first sleeve to an mounting surface of the collaborative robot for forming a first seal;
receiving the collaborative robot in the first sleeve, the first sleeve configured to define the external surface of the collaborative robot within the sleeve;
inserting the collaborative robot through a port, and into an inner volume, of the glovebox;
forming a second seal between the first sleeve and the port to prevent contaminants from migrating between an inner volume of the glovebox and the collaborative robot.

20. The method of claim 19, comprising coupling the tool mounting member to an end effector inside the glovebox.

21. The method of claim 19, wherein a glove is secured to port of the glovebox with an o-ring, the method comprising positioning the glove on a first o-ring groove of the port, positioning the first sleeve on a second o-ring groove of the port, and disconnecting the glove from the first o-ring groove.

22. The method of claim 19, comprising forming a seal between a second sleeve and the port of the glove box, and forming a seal between the second sleeve and the collaborative robot, wherein the second sleeve defines a portion of the first sleeve and the collaborative robot outside the glove box, wherein the first sleeve, the second sleeve, and the collaborative robot define a sealed volume of space.

23. The method of claim 22, comprising flowing air into a sealed volume of space defined by the first sleeve, the second sleeve, and the collaborative robot.

24. The method of claim 23, comprising filtering the air with a HEPA filter.
